(19) United States
(12) Patent Application Publication
(10) Pub. No.: US 2025/0198324 A1
(43) Pub. Date: Jun. 19, 2025

(54) AMPHIBIOUS VEHICLE WITH AIR AND LIQUID COOLING

(71) Applicant: Textron Systems Corporation, Hunt Valley, MD (US)

(72) Inventors: Wyatt Coleman Huling, JR., Slidell, LA (US); Jacob Martin Krabbenhoft, Slidell, LA (US); David Albert Jackson, Mandeville, LA (US)

(21) Appl. No.: 18/982,608

(22) Filed: Dec. 16, 2024

Related U.S. Application Data
(60) Provisional application No. 63/611,914, filed on Dec. 19, 2023.

(51) Int. Cl. F01P 3/18; B60K 11/06; B60K 11/08; F01P 5/06; F02B 29/04

(52) U.S. Cl. CPC F01P 3/18; B60K 11/06; B60K 11/085; F01P 5/06; F02B 29/0456

(57) ABSTRACT

An amphibious vehicle has a dual-mode cooling system to cool heat-generating components (e.g., engine, turbocharger) in both land and water operating modes, using air-cooling components (forced flow of ambient air) and liquid-cooling components (forced flow of ambient water) in the land and water modes respectively. The air-cooling components provide cooling of engine coolant and compressed intake air by (i) a radiator in a first loop carrying the engine coolant and (ii) an air-air charge air cooler (CAC) in a second loop carrying the compressed intake air, and the liquid-cooling components provide cooling of engine coolant and compressed intake air by (iii) a liquid-liquid heat exchanger in series with the radiator in the first loop and (iv) a liquid-air CAC in series with the air-air CAC in the second loop. Additional heat exchangers may be used for cooling a swim rudder, transmission and transfer case.

### BACKGROUND

The invention is related to the field of amphibious vehicles, and in particular to cooling systems for heat-generating components (e.g., internal combustion engine, turbocharger) in amphibious vehicles.

### SUMMARY

While operating an amphibious vehicle in open ocean or surf zone environments, the need for powertrain cooling increases, as the vehicle's air-to-air and air-to-water heat exchangers are blocked off from ambient airflow to prevent internal water ingestion. A disclosed approach provides for switching between air-based cooling and water-based cooling during land and amphibious (water) operations, respectively.

More specifically, a dual-mode cooling system is configured and operative to cool the heat-generating components in both the land operating mode and the distinct water operating mode, by (1) air-cooling components to provide cooling by forced flow of ambient air in the land operating mode, and (2) liquid-cooling components to provide cooling by forced flow of ambient water in the water operating mode. The heat-generating components can include an internal combustion engine, for which (1) the air-cooling components include a radiator operative to cool a flow of engine coolant by the forced flow of ambient air in the land operating mode, and (2) the liquid-cooling components include a liquid-liquid heat exchanger operative to cool the flow of engine coolant by the forced flow of ambient water in the water operating mode. Heat-generating components may further include a turbo charger for compressing intake air for the internal combustion engine, for which (1) the air-cooling components include an air-air charge air cooler (CAC) to cool a flow of compressed and heated intake air by the forced flow of ambient air in the land operating mode, and (2) the liquid-cooling components include a liquid-air CAC operative to cool the flow of the compressed and heated intake air by the forced flow of ambient water. Various other specifics and alternatives are also described.

The disclosed system can avoid limitations and drawbacks of known amphibious vehicles. Known calm-water vehicles continue to use the land operation coolers in a limited way, which prevents them from operating in more turbulent water such as open ocean and surf zones. Known open-ocean capable vehicles flood the cooling compartment to operate the air-based coolers as liquid-based coolers, which reduces vehicle buoyancy and requires additional vehicle weight to maintain seaworthiness.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views.

FIG. 1 is an isometric perspective view of an amphibious vehicle;

FIG. 2 is an isometric perspective view of an upper front part of the amphibious vehicle;

FIG. 3 is a right-side elevation view of an engine compartment of the amphibious vehicle;

FIG. 4 is a left-side elevation view of the engine compartment of the amphibious vehicle;

FIG. 5 is an elevation view of an engine and first set of cooling components used in a land mode (air cooled) of operation;

FIG. 6 is an isometric perspective view of the engine and a second set of cooling components used in a swim mode (liquid cooled) of operation;

FIG. 7 is an isometric perspective view of the engine with both the first and second sets of cooling components as well as additional components used in the swim mode (liquid cooled) of operation;

FIG. 8 is a second isometric view of the arrangement of FIG. 7, seen from a lower left position;

FIG. 9 is an isometric perspective view of a portion of an air intake grille in an open position permitting air flow therethrough;

FIG. 10 is an isometric perspective view of the portion of the air intake grille in a closed position not permitting air flow therethrough;

FIG. 11 is a schematic diagram of cooling system components and flow of coolant media in the land mode (air cooled) of operation; and

FIG. 12 is a schematic diagram of cooling system components and flow of coolant media in the swim mode (liquid cooled) of operation.

### DETAILED DESCRIPTION

### Overview

Amphibious vehicles have particular needs for cooling their engines and other heat-generating components, which arise from their ability to operate in two distinct modes: land-based operation and water-based (“swim”) operation. In some solutions, a single set of air-cooled heat exchangers is used for both operating modes. Due to the potential for water ingestion during swim mode, such vehicles may be limited to use in calm water only and not in other environments such as a surf zone transition from beach to open sea for example. In another approach, air-cooled heat exchangers may be flooded with water during swim mode to effectively convert them to water-cooled, but such an approach adversely affects craft buoyancy and may require increased weight to maintain seaworthiness.

In a disclosed approach, a cooling system can switch from air-based cooling to liquid-based cooling during land and water operations, respectively. The cooling system employs a contained, flow-through system, and thus does not require a floodable volume and avoids the issues of reduced buoyancy of prior approaches, while achieving similar or better cooling efficiencies.

In one aspect, an amphibious vehicle uses a first air-based engine cooling approach for land operations, including the use of a radiator for engine cooling and charge air cooler (CAC) for cooling of compressed intake gas from a turbocharger. The radiator, CAC, and a hydraulically powered fan are all positioned on the same plane directly above the engine compartment. To create heat transfer in the cooling system, the fan pushes air out of the vehicle's engine compartment, creating a slight vacuum relative to atmospheric pressure. The vacuum forces ambient air to then pass through each heat exchanger, flow downward through the engine compartment, and eventually be exhausted by the fan, effectively causing convective heat transfer.

Hot engine coolant exits the engine and passes into the radiator where it is cooled by the airflow over the radiator fins during land operation. The coolant exits the radiator and enters a shell and tube heat exchanger before returning into the engine block. During swim mode, the radiator becomes passive as airflow is stopped (details below), and the shell and tube heat exchanger performs the function of cooling the engine coolant. Raw water (e.g., seawater) is pumped through the shell and tube heat exchanger and serves to cool the hot engine coolant.

The charge air cooler (CAC) is responsible for cooling combustion air before it enters the engine. The combustion air is produced by a turbocharger, which necessarily heats combustion air as a by-product of pressurizing it. The CAC is a heat exchanger like a radiator. For land operation, an air-to-air CAC is used in which the compressed combustion gas is passed through finned tubes, with ambient air being drawn across the fins by the fan. The system also employs a liquid-to-air CAC that performs the function of cooling the combustion gas during swim mode. The liquid-to-air CAC is in line with the air-to-air CAC, and when one is used for the corresponding mode, the other is passive, like the arrangement for the engine coolant.

In one embodiment the radiator and CAC are operated under a large perforated/slotted grille that operates as a large valve or shutter. With the grille in an open position during land operation, cooling air is drawn into the engine compartment by the cooling fan and flows over the radiator and CAC to effect cooling. The grille is closed during water operation when water-based cooling is used, to prevent intrusion of raw water. The grille may consist of two perforated plates arranged for a sliding movement between open and closed positions. In the open position the perforations (e.g., slots) are aligned and permit airflow. In the closed position, the perforations of each plate are blocked by solid structure of the other plate, preventing entry of raw water while the liquid-based cooling components are used.

To replace the air flow over the radiator and CAC when the grille is closed, the vehicle then switches to a raw water-cooled system. The raw water is pumped in series into the liquid-to-air CAC first, with the outlet hose feeding directly into the inlet of the tubes within the shell and tube heat exchanger. After the coolant water passes through the shell and tube heat exchanger, it traverses an outlet hose routed to a discharge port on the side of vehicle, disposing of the spent water overboard. When the raw water-cooling loop is active, the radiator and air-to-air CAC are both passive, since the slotted grille is closed, and no airflow is being passed through them.

To move the raw water through the liquid-to-air CAC and shell and tube heat exchanger, a pump draws in water via a screened inlet on the lower hull. After the water enters through the screened inlet, it first passes through a strainer to catch any debris or vegetation that may have been introduced. This strainer has a timed grinder wheel that churns the debris into small bits and discards the contents overboard via a second outlet port on the hull, ensuring the pump does not send harmful debris into each heat exchanger. To activate the raw water pump only when it is needed, an optical water sensor is installed on an unused outlet port of the strainer. This sensor detects water as soon as the vehicle enters the water, as the strainer is below the water line of the vehicle when swimming, also removing the need for a self-priming pump. Additionally, this sensor is only activated when the driver prompts the vehicle to enter swim mode. When the vehicle exits the water, the pump turns off, as water is no longer present. The driver then deactivates swim mode, opening the slotted grille and allowing the fan to draw air through the radiator and air-to-air CAC again. The liquid-to-air CAC and shell and tube heat exchanger then return to a passive state and do not provide any heat transfer to the land mode cooling system.

### Embodiments

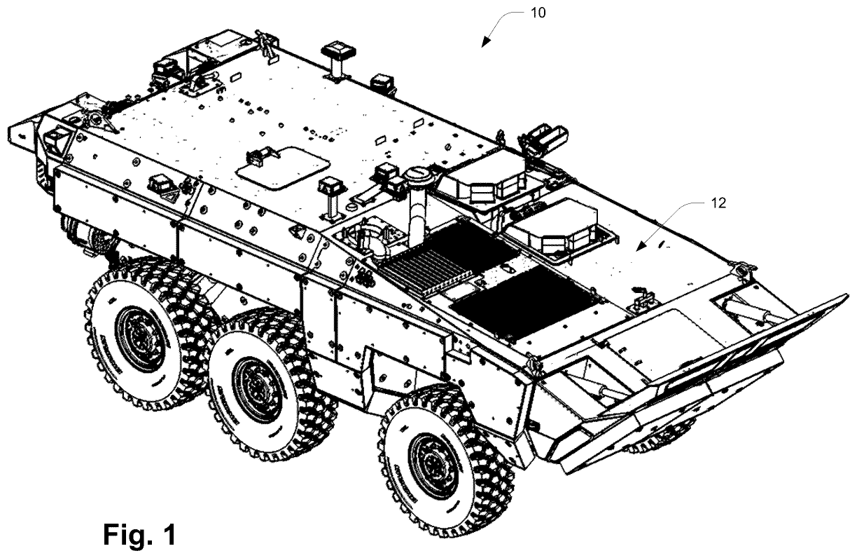

FIG. 1 shows an amphibious vehicle 10 of a type that can use and benefit from a dual-mode cooling approach as described herein. The vehicle 10 has components and functions enabling it to operate both on land and in water. As vehicles of this general type are known, their details are not elaborated herein. The present description is focused on particular structure and functionality that can be used in such vehicles, namely, the ability to provide required cooling of heat-generating components such as an engine and associated turbocharger. In vehicle 10 such heat-generating and cooling components are housed in a forward area 12. Details are described below.

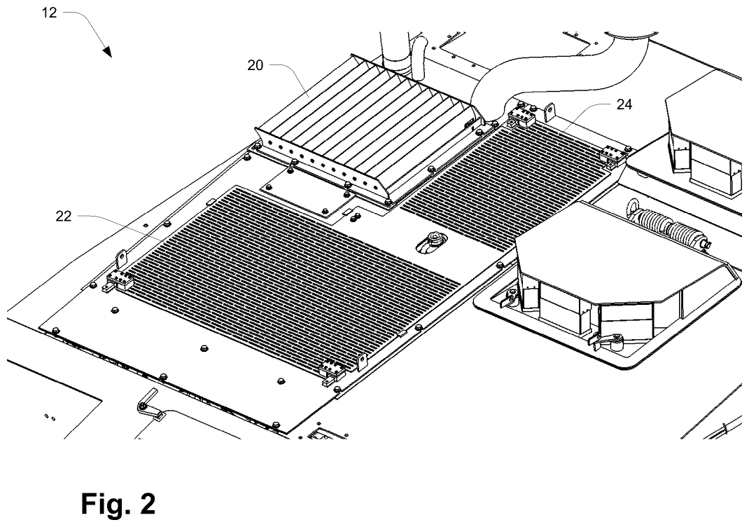

FIG. 2 shows exterior components mounted at an upper part of forward area 12 of vehicle 10. These include a fan 20, intake air grille 22 (arranged above an internal radiator, not visible), and air-air charge air cooler (CAC) 24. During land mode (air cooled) operation, grille 22 is open to permit airflow. Fan 20 operates as an exhaust fan, pulling ambient air into the underlying engine compartment through the radiator and CAC 24 and then blowing this heated air out to atmosphere. In swim mode (liquid cooled), grille 22 is closed to prohibit passage of raw water, and fan 20 is not operated. Details of land-mode and swim-mode cooling are described further below.

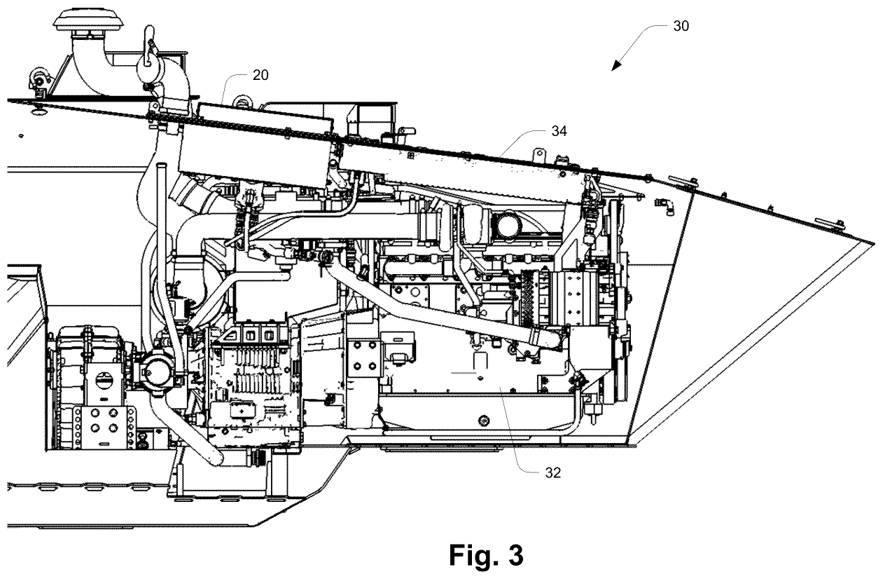

FIG. 3 is a right-side view of the engine compartment 30 that sits directly below the upper area shown in FIG. 2. It houses an engine 32 and a number of other components including the above-mentioned radiator 34. Other details are visible but their description is deferred to later figures.

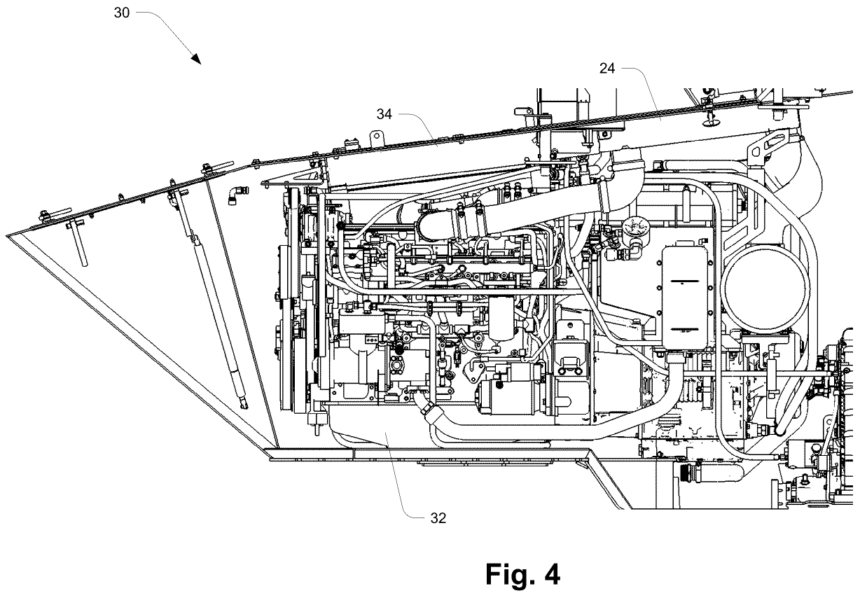

FIG. 4 is a left-side view of engine compartment 30, showing the engine 32 and other components including the radiator 34 and air-air CAD 24. Other details are visible but their description is deferred to later figures.

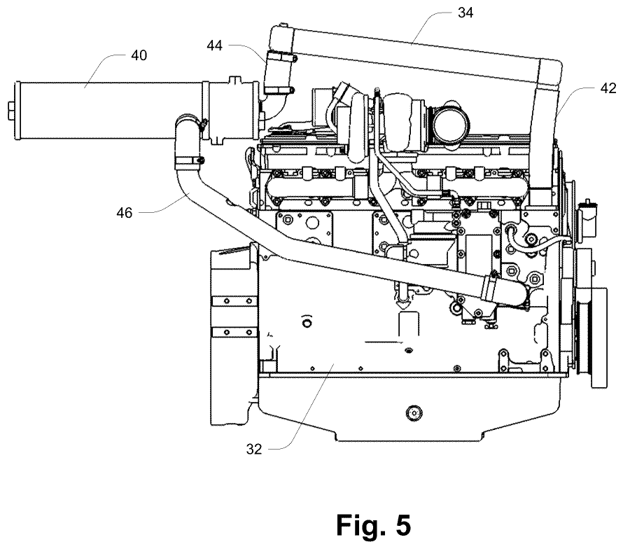

FIG. 5 is a view of the components used for cooling heated engine coolant (other components being hidden in this view). A set of pipes/hoses is used to connect the engine 32, radiator 34 and a shell-and-tube (ST) heat exchanger 40 in a closed loop, with coolant flowing from a coolant exit of engine 32 through hose 42, radiator 34, hose 44, ST heat exchanger 40, and hose 46 back to a coolant inlet of the engine 32. In land mode of operation, cooling air flows downward through the radiator 34 to cool the hot coolant, which then traverses the inactive ST each exchanger 40 and returns to the engine 32. In swim mode, hot coolant from the engine flows through the inactive radiator 34 and is liquid-cooled in the ST heat exchanger 40, before returning in a cooled state to the engine 32. Additional structural and operational details are given below.

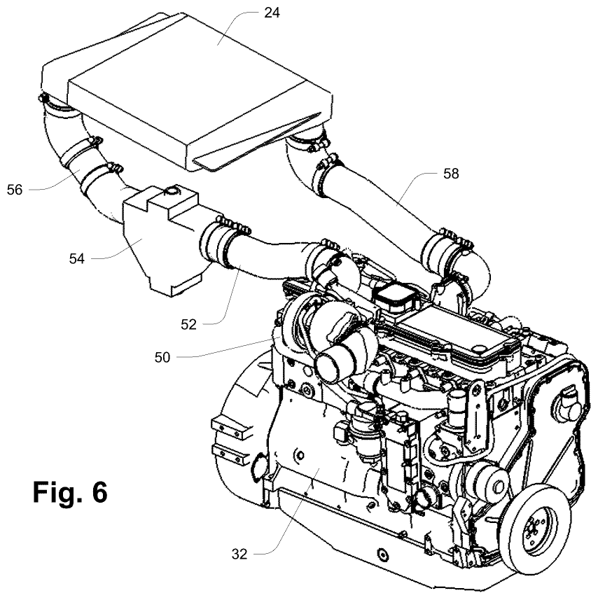

FIG. 6 is a view of the components used for cooling intake air generated by an exhaust-powered turbocharger 50. Heated air flows through a closed loop including a hose 52, a liquid-air CAC 54, hose 56, air-air CAC 24, and hose 58 into the intake manifold 59 of the engine 32. In land mode, the heated air traverses the inactive liquid-air CAC 54 and is cooled by airflow through the air-air CAC 24, then supplied in cooled state to the intake manifold 59. In swim mode, the heated air is liquid-cooled by the liquid-air CAC 54, then the cooled air traverses the inactive air-air CAC 24 and is supplied to the intake manifold 59.

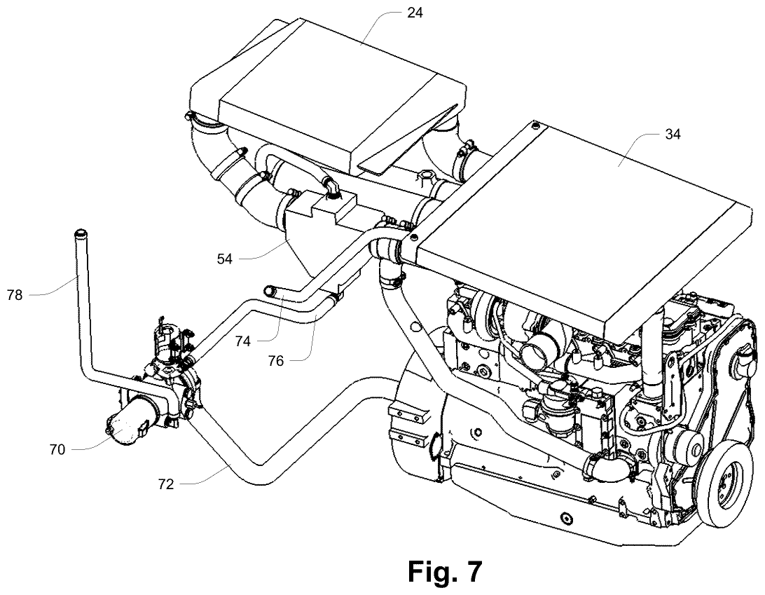

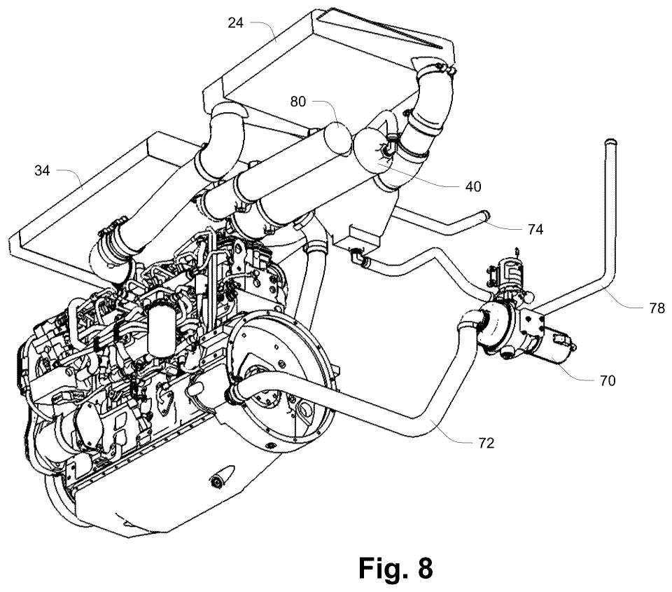

FIGS. 7 and 8 show additional details of components used for carrying raw water which serves as the liquid cooling medium in swim mode. These include a pump and strainer assembly 70 (also referred to as simply “pump”), intake pipe 72 and outflow pipe 74, hose 76 connecting the pump 70 to the liquid-air CAC 54, and a discharge pipe 78 for strained-out material. In land mode of operation, the pump 70 is quiescent and no cooling water flows. In swim mode, the pump 70 filters incoming raw water and induces flow of coolant water in the rest of the loop. Heated intake air is cooled by liquid-air CAC 54, and engine coolant is heated by ST heat exchanger 40. Also shown in FIG. 8 is an additional ST heat exchanger 80 whose function is described further below.

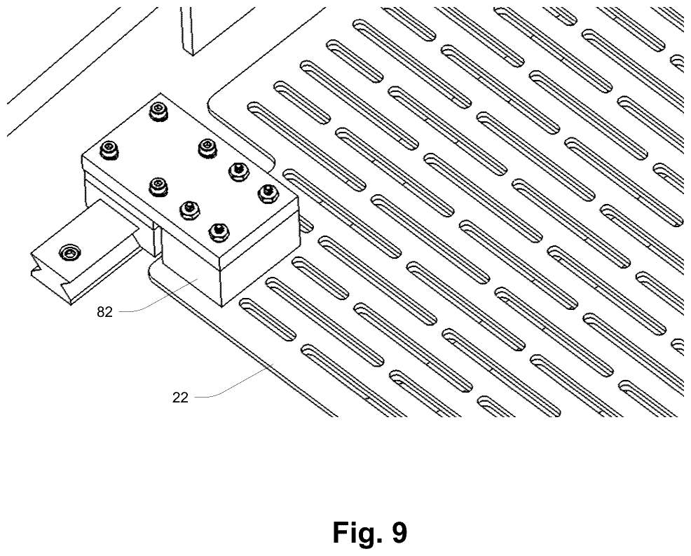

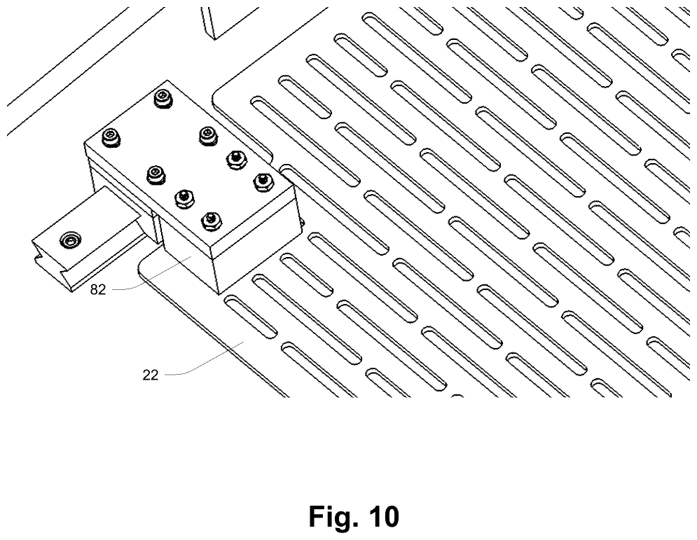

FIGS. 9 and 10 show details and operation of the intake air grille 22. It consists of a pair of plates having matching slot-shaped perforations and driven by a linear actuator (not shown) on the rear of the grille 22. The linear actuator is operated to slide the upper or top plate relative to the lower/bottom plate and thereby move the grille between open and closed positions. A guide block 82 is disposed at one end of the top plate while enabling it to slide relative to the bottom plate. FIG. 9 shows the open position in which the perforations of both plates are aligned, enabling the passage of air into the engine compartment by operation of fan 20 as described above. FIG. 10 shows the closed position in which the perforations of each plate are covered by respective solid surfaces of the other plate, preventing the passage of air into the engine compartment for swim mode of operation. In one embodiment, the slots of the plates may be approximately 3.5″ long by 0.5 inches in width, with 1.5″ spacing. Numerous other arrangements are of course possible.

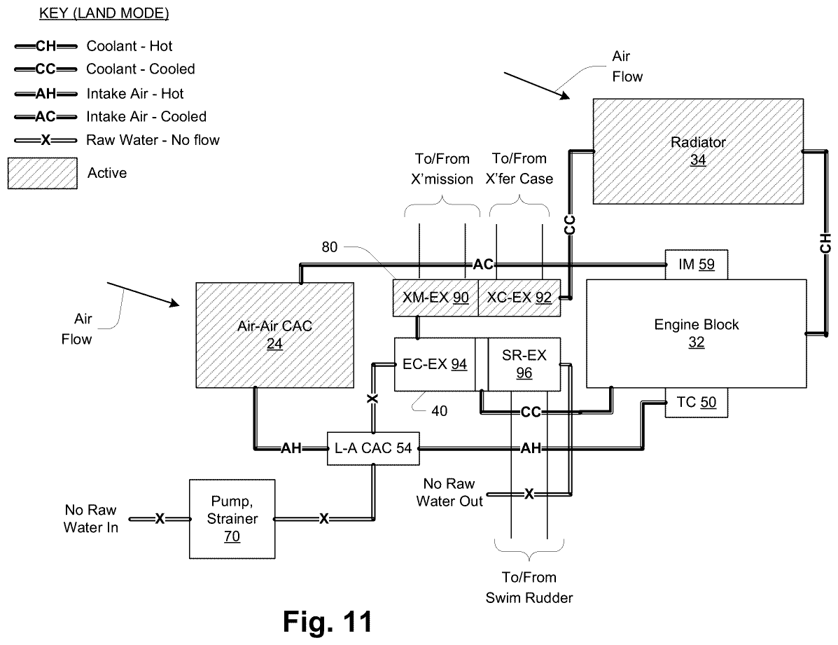

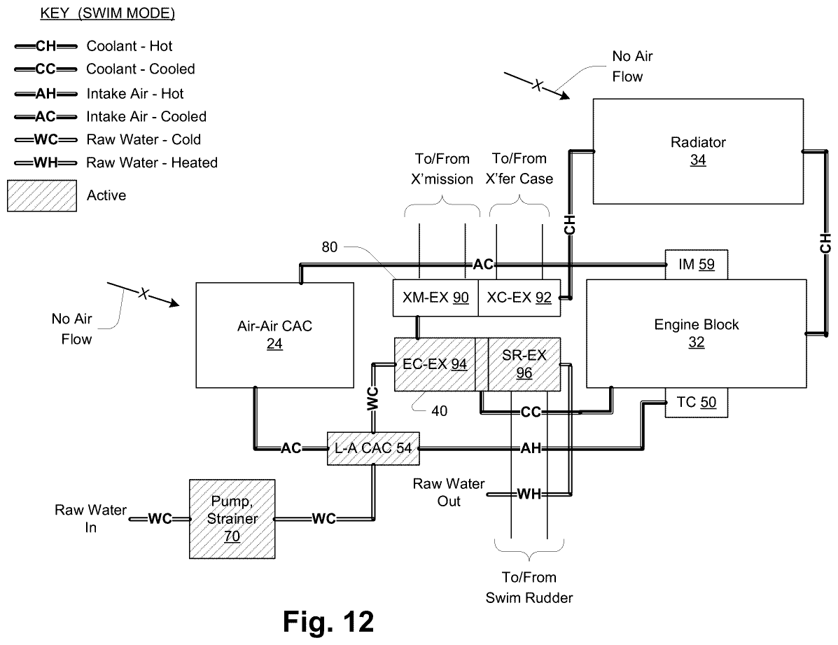

FIGS. 11 and 12 are schematic diagrams used to illustrate the two distinct modes of operation, swim mode (liquid cooled) and land mode (air cooled). In each diagram the active components are identified with shading as shown and indicated. Also shown is a key identifying the following media:
a. CH—Engine coolant—hot
b. CC—Engine coolant—cooled
c. AH—Intake air—hot
d. AC—Intake air—cooled
e. WC—Raw Water—cold
f. WH—Raw Water—heated
g. X—Raw Water not flowing

FIG. 11 illustrates air cooled (land mode) of operation, in which the radiator 34, air-air CAC 24 and heat exchanger 80 are active based on forced air flow through the engine compartment as described above. Hot engine coolant CH flows through the radiator 34 where it is cooled, producing cooled engine coolant CC which flows through the two heat exchangers 80, 40 and then back to the engine 32. The heat exchanger 80 has two sub-units, a transmission heat exchanger (XM-EX) 90 for cooling transmission fluid and a transfer-case exchanger (XC-EX) 92 for cooling transfer case fluid. It will be appreciated that these heat exchangers do have a heating effect on the cooled coolant CC, but the system is designed so that there is ample thermal removal to handle this heating effect as well as the much larger effect of the engine 32.

FIG. 11 also shows the cooling of intake air, which is produced as heated intake air AH by the turbocharger 50. This heated air passes through the liquid-air CAC 54 and is cooled by the air-air CAC 24 to produce cooled intake air AC provided to the intake manifold (IM) 59.

Also in FIG. 11 the label “X” is used to indicate that there is no flow of cooling raw water, so the pump 70, liquid-air CAC 54 and heat exchanger 40 are all effectively passive and produce no cooling effect.

FIG. 12 illustrates liquid cooled (swim mode) of operation, in which the pump 70, liquid-air CAC 54 and heat exchanger 40 are active. The pump 70 produces cold raw water WC that flows through the liquid-air CAC 54 and the heat exchanger 40, producing heated raw water WH that is discharged externally via outflow pipe 74 as mentioned in reference to FIG. 8 above. Hot engine coolant CH flows through the radiator 34 and the heat exchanger 80 into the heat exchanger 40 where it is cooled, producing cooled engine coolant CC which flows back to the engine 32. Heat exchanger 40 has two sub-units, an engine coolant heat exchanger (EC-EX) 94 for cooling the engine coolant and a swim-rudder exchanger (SR-EX) 96 for cooling swim rudder hydraulic fluid. In this mode the heat exchangers 90, 92 add additional heat to the flowing hot coolant CH, so the engine coolant exchanger 94 provides sufficient thermal removal to handle this heating effect as well as the much larger effect of the engine 32.

FIG. 12 also shows the cooling of intake air, which is produced as heated intake air AH by the turbocharger 50. The liquid-air CAC 54 cools this heated air to produce cooled intake air AC which passes through the air-air CAC 24 and is provided to the intake manifold (IM) 59. In FIG. 12 the label “X” is used to indicate that there is no flow of cooling air, so the air-air CAC 24 and radiator 34 are effectively passive and produce no cooling effect.

The individual features of the various embodiments, examples, and implementations disclosed within this document can be combined in any desired manner that makes technological sense. Furthermore, the individual features are hereby combined in this manner to form all possible combinations, permutations and variants except to the extent that such combinations, permutations and/or variants have been explicitly excluded or are impractical. Support for such combinations, permutations and variants is considered to exist within this document.

While various embodiments of the invention have been particularly shown and described, it will be understood by those skilled in the art that various changes in form and details may be made therein without departing from the scope of the invention as described herein.

What is claimed is:

1. An amphibious vehicle, comprising:
one or more heat-generating components; and
a dual-mode cooling system configured and operative to cool the heat-generating components in both a land operating mode and a distinct water operating mode, by (1) air-cooling components to provide cooling by forced flow of ambient air in the land operating mode, and (2) liquid-cooling components to provide cooling by forced flow of ambient water in the water operating mode.

2. The amphibious vehicle of claim 1, wherein the heat-generating components include an internal combustion engine, and wherein (1) the air-cooling components include a radiator operative to cool a flow of engine coolant by the forced flow of ambient air in the land operating mode, and (2) the liquid-cooling components include a liquid-liquid heat exchanger operative to cool the flow of engine coolant by the forced flow of ambient water in the water operating mode.

3. The amphibious vehicle of claim 2, wherein the heat-generating components further include a turbo charger for compressing intake air for the internal combustion engine, and wherein (1) the air-cooling components include an air-air charge air cooler (CAC) to cool a flow of compressed and heated intake air by the forced flow of ambient air in the land operating mode, and (2) the liquid-cooling components include a liquid-air CAC operative to cool the flow of the compressed and heated intake air by the forced flow of ambient water.

4. The amphibious vehicle of claim 2, further comprising a perforated grille operable in an open position during the land operating mode and in a closed position during the water operating mode, the grille in the open position enabling the ambient air to be drawn into an engine compartment by a cooling fan and to flow over the radiator to effect cooling, the grille in the closed position preventing intrusion of the ambient water into the engine compartment.

5. The amphibious vehicle of claim 4, wherein the grille has two perforated plates arranged for a relative sliding movement between the open and closed positions, with respective perforations of the plates being aligned to permit airflow in the open position and being non-aligned to prevent entry of ambient water in the closed position.

6. The amphibious vehicle of claim 5, wherein the radiator is located adjacent an opening of an upper body surface of the vehicle, and the grille is located in the opening.

7. The amphibious vehicle of claim 1, wherein the heat-generating components include an internal combustion engine and a turbo charger for compressing intake air for the internal combustion engine, and wherein (1) the air-cooling components include first and second air-cooling components for cooling respective flows of engine coolant and compressed and heated intake air by the forced flow of ambient air in the land operating mode, and (2) the liquid-cooling components include first and second liquid-cooling components for cooling the respective flows of engine coolant and compressed and heated intake air by the forced flow of ambient water in the water operating mode.

8. The amphibious vehicle of claim 7, wherein the first and second air-cooling components include a radiator and an air-air charge air cooler (CAC) respectively, and the first and second liquid-cooling components include a liquid-liquid heat exchanger and a liquid-air CAC respectively, the radiator and liquid-liquid heat exchanger being in series in a first loop carrying the flow of engine coolant, the air-air CAC and liquid-air CAC being in series in a second loop carrying the compressed and heated intake air.

9. The amphibious vehicle of claim 8, wherein the first loop further includes respective air-liquid heat exchanges for cooling respective flows of transmission coolant and transfer case coolant respectively in the land operating mode.

10. The amphibious vehicle of claim 8, wherein the first loop further includes an additional liquid-liquid heat exchanger for cooling a flow of swim rudder coolant in the water operating mode.

11. The amphibious vehicle of claim 1, further including components for producing and carrying the forced flow of ambient water, including a pump and strainer assembly, intake pipe, outflow pipe, interconnecting hoses and a discharge pipe for discharging strained-out material, the pump being quiescent during the land mode of operation such that no forced flow of ambient water is produced, the pump being active during the water operating mode to filter incoming ambient water and produce the forced flow of ambient water.

12. An amphibious vehicle, comprising:
a turbocharged internal combustion engine having (1) an engine block configured for cooling by a flow of engine coolant and (2) a turbocharger configured for cooling by a flow of compressed intake air; and
a dual-mode cooling system configured and operative to cool the engine block and turbocharger in both a land operating mode and a distinct water operating mode, including (1) air-cooling components to provide cooling of the engine coolant and the compressed intake air by forced flow of ambient air in the land operating mode, and (2) liquid-cooling components to provide cooling of the engine coolant and compressed intake air by forced flow of ambient water in the water operating mode, the air-cooling components including (i) a radiator in a first loop carrying the engine coolant and (ii) an air-air charge air cooler (CAC) in a second loop carrying the compressed intake air, the liquid-cooling components including (iii) a liquid-liquid heat exchanger in series with the radiator in the first loop and (iv) a liquid-air CAC in series with the air-air CAC in the second loop.

13. The amphibious vehicle of claim 12, further comprising a perforated grille operable in an open position during the land operating mode and in a closed position during the water operating mode, the grille in the open position enabling the ambient air to be drawn into an engine compartment by a cooling fan and to flow over the radiator to effect cooling, the grille in the closed position preventing intrusion of the ambient water into the engine compartment.

14. The amphibious vehicle of claim 13, wherein the grille has two perforated plates arranged for a relative sliding movement between the open and closed positions, with respective perforations of the plates being aligned to permit airflow in the open position and being non-aligned to prevent entry of ambient water in the closed position.

15. The amphibious vehicle of claim 14, wherein the radiator is located adjacent an opening of an upper body surface of the vehicle, and the grille is located in the opening.

16. The amphibious vehicle of claim 12, wherein the first loop further includes respective air-liquid heat exchanges for cooling respective flows of transmission coolant and transfer case coolant respectively in the land operating mode.

17. The amphibious vehicle of claim 12, wherein the first loop further includes an additional liquid-liquid heat exchanger for cooling a flow of swim rudder coolant in the water operating mode.

18. The amphibious vehicle of claim 12, further including components for producing and carrying the forced flow of ambient water, including a pump and strainer assembly, intake pipe, outflow pipe, interconnecting hoses and a discharge pipe for discharging strained-out material, the pump being quiescent during the land mode of operation such that no forced flow of ambient water is produced, the pump being active during the water operating mode to filter incoming ambient water and produce the forced flow of ambient water.
